(19) United States
(12) Patent Application Publication
(10) Pub. No.: US 2008/0303752 A1
(43) Pub. Date: Dec. 11, 2008

(54) PLASMA DISPLAY APPARATUS AND METHOD OF DRIVING THE SAME

(76) Inventors: Younghan LEE, Seoul (KR); Jeongpil Choi, Seoul (KR)

Correspondence Address: KED & ASSOCIATES, LLP, P.O. Box 221200, Chantilly, VA, 20153-1200, US

(21) Appl. No.: 12/133,711

(22) Filed: Jun. 5, 2008

(30) Foreign Application Priority Data
Jun. 11, 2007 (KR) 10 -2007-0056807

(51) Int. Cl. G09G 3/28

(52) U.S. Cl. 345/60; 315/169.4

(57) ABSTRACT

A plasma display apparatus and a method of driving the same are disclosed. The driving method supplies a data signal whose on-time is longer than off-time. The plasma display apparatus includes a data driver including a data integrated circuit (IC) and an energy recovery unit. The data IC allows one of a plurality of output terminals to be in an on-state and allows at least one of the other output terminals to be in an off-state during off-time shorter than on-time of the on-state.

This application claims the benefit of Korean Patent Application No. 10-2007-0056807 filed on Jun. 11, 2007, which is hereby incorporated by reference.

### BACKGROUND OF THE DISCLOSURE

1. Field of the Disclosure

An exemplary embodiment relates to a plasma display apparatus and a method of driving the same.

2. Description of the Background Art

A plasma display apparatus generally includes a plasma display panel displaying an image, and a driver attached to the rear of the plasma display panel to drive the plasma display panel.

The plasma display panel includes a front substrate and a rear substrate which are spaced apart from each other at a given interval therebetween, and barrier ribs for forming a plurality of discharge cells between the front substrate and the rear substrate. Each discharge cell is filled with an inert gas containing a main discharge gas such as neon (Ne), helium (He) or a mixture of Ne and He, and a small amount of xenon (Xe). Red, green, and blue discharge cells form one pixel.

When the plasma display panel is discharged by a high frequency voltage, the inert gas generates vacuum ultraviolet rays, which thereby cause phosphors formed between the barrier ribs to emit light, thus displaying an image.

The plasma display panel includes a plurality of electrodes, for instance, a scan electrode, a sustain electrode, and an address electrode. The drivers for supplying driving voltages to the electrodes of the plasma display panel are connected to the electrodes, respectively.

When the plasma display panel is driven, each driver supplies a driving signal such as a reset signal, a scan signal, and a sustain signal to the electrode during a predetermined period, for example, a reset period, an address period, and a sustain period to emit light inside the discharge cells.

An energy recovery circuit supplies a power required in a discharge to the electrode and recovers energy from the electrode. Therefore, the energy recovery circuit is necessary to drive a sustain signal. The energy recovery circuit is also used to increase the drive efficiency of a data integrated circuit (IC). A drive operation of the energy recovery circuit is the same as a drive operation of the sustain signal. Energy recovery and supply operations for driving the data IC are performed through power pins of the data IC. The energy recovery circuit is installed outside the data IC.

### SUMMARY OF THE DISCLOSURE

A method of driving a plasma display apparatus including a plurality of data channels, the method comprises supplying a data signal whose on-time is longer than off-time.

While one of the plurality of data channels is maintained in an on-state, energy may be supplied to or recovered from at least one of the other data channels.

After energy is supplied to one of the plurality of data channels, energy may be recovered from at least one of the other data channels. Further, after energy is supplied to the at least one of the other data channels, energy may be recovered from the one of the plurality of data channels.

A plasma display apparatus comprises a data driver including a data integrated circuit (IC) and an energy recovery unit, wherein the data IC allows one of a plurality of output terminals to be in an on-state and allows at least one of the other output terminals to be in an off-state during off-time shorter than on-time of the on-state.

The data IC may include a first terminal connected to a data voltage source, a second terminal connected to ground, a third terminal connected to an energy supply and recovery terminal of the energy recovery unit, and a fourth terminal connected to the plurality of output terminals.

The data IC may include as many 21-circuits as the number of data channels. The 21-circuit may include a 21-high switch and a 21-low switch that are connected in series between the first terminal and the second terminal, a node between the 21-high switch and the 21-low switch may be connected to the output terminal, and a 21-switch may be connected between the third terminal and the node.

The energy recovery unit may include a 21-capacitor connected between the third terminal and ground, and a 21-inductor connected between the third terminal and the 21-capacitor.

The data IC may include as many 21-circuits as the number of data channels. The 21-circuit may include a 21-high switch and a 21-low switch that are connected in series between the first terminal and the second terminal, a node between the 21-high switch and the 21-low switch may be connected to the output terminal, and a 21-switch may be connected between the third terminal and the node. The energy recovery unit may include a 21-capacitor connected between the third terminal and ground, and a 21-inductor connected between the third terminal and the 21-capacitor.

The data IC may include a first terminal connected to an energy supply terminal of the energy recovery unit, a second terminal connected to an energy recovery terminal of the energy recovery unit, and a third terminal connected to the plurality of output terminals. The first terminal and the second terminal may be separated from each other.

The data IC may include as many 31-circuits as the number of data channels. The 31-circuit may include a 31-high switch and a 31-low switch that are connected in series between the first terminal and the second terminal, and a node between the 31-high switch and the 31-low switch may be connected to the output terminal.

The energy recovery unit may include a 31-switch connected between a data voltage source and the energy supply terminal, a 32-switch whose one terminal is connected to the energy supply terminal, a 31-inductor whose one terminal is connected to the other terminal of the 32-switch, a 34-switch connected between ground and the energy recovery terminal, a 33-switch whose one terminal is connected to the energy recovery terminal, a 32-inductor whose one terminal is connected to the other terminal of the 33-switch, and a 31-capacitor whose one terminal is connected to the other terminal of the 31-inductor and the other terminal of the 32-inductor, and the other terminal is connected to ground.

### BRIEF DESCRIPTION OF THE DRAWING

The accompany drawings, which are included to provide a further understanding of the invention and are incorporated on and constitute a part of this specification, illustrate embodiments of the invention and together with the description serve to explain the principles of the invention. In the drawings:

FIG. 1 is a waveform diagram applied to a data channel for explaining a method of driving a plasma display apparatus according to an exemplary embodiment;

FIG. 2A is a circuit diagram of a data driver of the plasma display apparatus;

FIG. 2B is a timing chart of a waveform for explaining an operation of the circuit shown in FIG. 2A;

FIG. 3A is a circuit diagram of another data driver of the plasma display apparatus; and

FIG. 3B is a timing chart of a waveform for explaining an operation of the circuit shown in FIG. 3A.

### DETAILED DESCRIPTION OF EMBODIMENTS

Reference will now be made in detail embodiments of the invention examples of which are illustrated in the accompanying drawings.

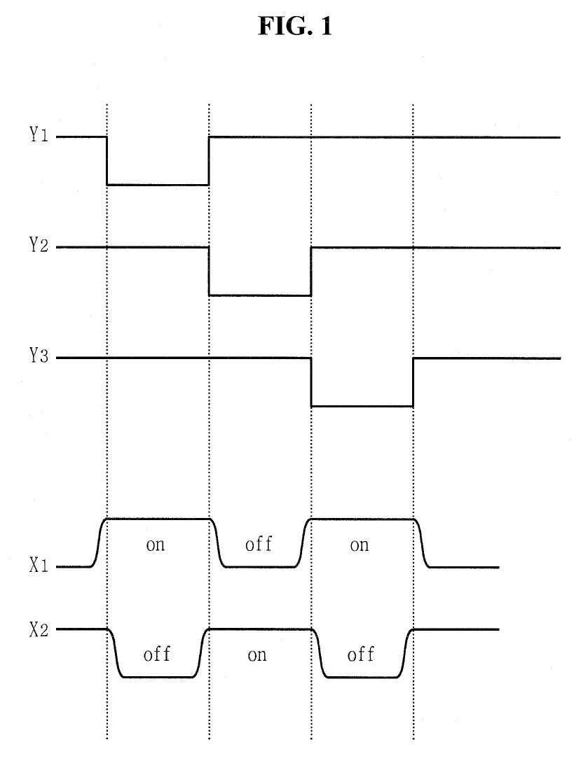

FIG. 1 is a waveform diagram applied to a data channel for explaining a method of driving a plasma display apparatus according to an exemplary embodiment.

As shown in FIG. 1, the method of driving the plasma display apparatus according to the exemplary embodiment allows on-time of a data signal to be longer than off-time of the data signal. The driving method applies an energy recovery or supply waveform to one channel X2 of a plurality of data channels X1 and X2 while another channel X1 is maintained in an on-state.

More specifically, after energy is supplied to the channel X1 of the plurality of data channels X1 and X2, energy is recovered from the channel X2. After energy is supplied to the channel X2, energy is recovered from the channel X1. The channels X1 and X2 do not have to be adjacent to each other. In other words, one channel X1 of the plurality of data channels X1 and X2 is in an on-state, and the other channel X2 is in an off-state.

While the channel X1 is maintained in the on-state, the channel X2 goes through an energy recovery operation, an off-state, and an energy supply operation. Because an energy recovery or supply switch corresponding to the channel X1 and an energy recovery or supply switch corresponding to the channel X2 are not simultaneously turned on, there is no short between the channels X1 and X2. Accordingly, the normal energy recovery and supply operations between the channels X1 and X2 are performed.

As shown in FIG. 1, the driving method of the plasma display apparatus according to the exemplary embodiment allows the on-time of the data signal to be longer than the off-time of the data signal. Hence, because a width of a data signal corresponding to a scan signal applied to scan electrodes Y1, Y2, and Y3 widens, sufficient address discharge time capable of generating a stable address discharge can be secured and a jitter characteristic can be improved.

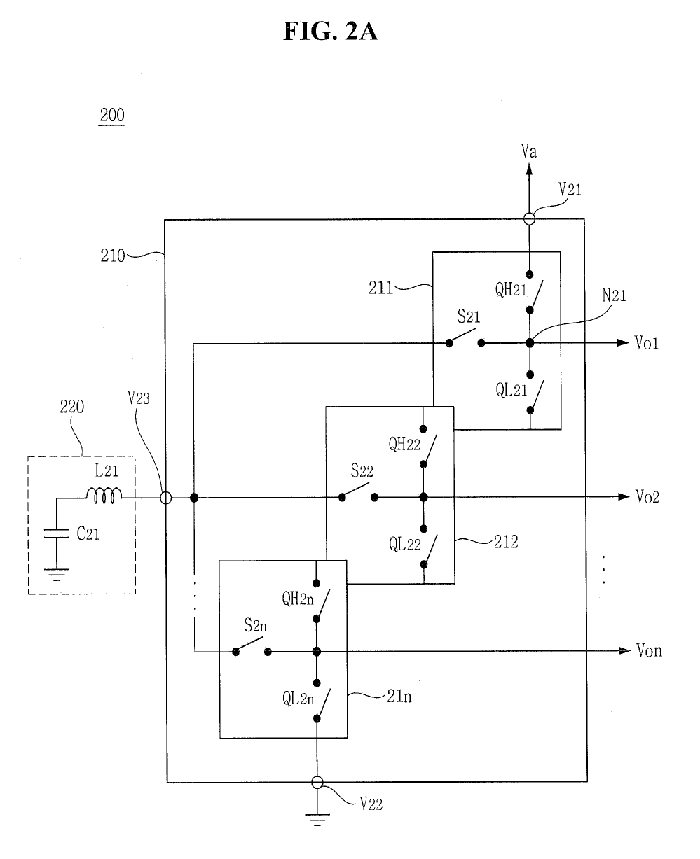

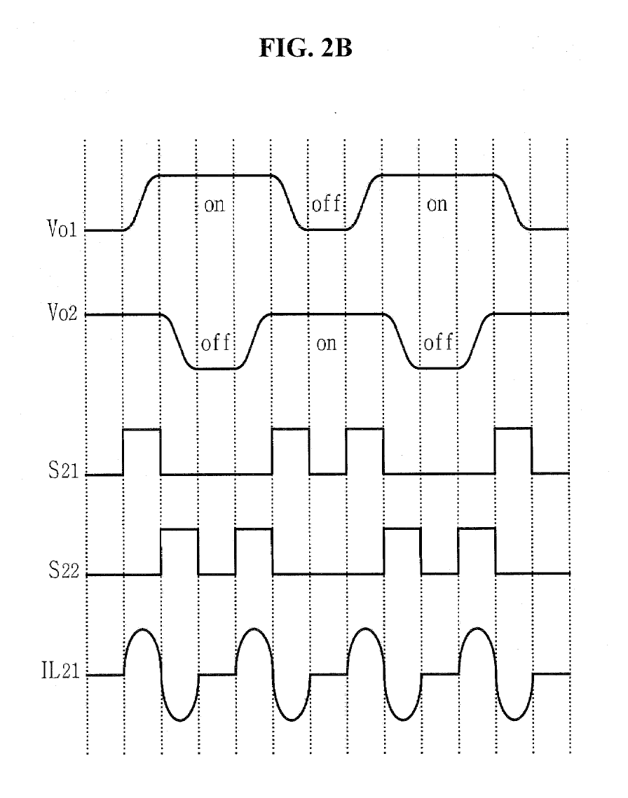

FIG. 2A is a circuit diagram of a data driver of the plasma display apparatus, and FIG. 2B is a timing chart of a waveform for explaining an operation of the circuit shown in FIG. 2A.

As shown in FIGS. 2A and 2B, the plasma display apparatus includes a data driver 200. The data driver 200 includes a data integrated circuit (IC) 210 and an energy recovery unit 220. The data IC 210 allows one of a plurality of output terminals Vo1, . . . , Von to be in an on-state, and allows at least one of the other output terminals to be in an off-state during off-time shorter than on-time of the on-state.

The data IC 210 includes a first terminal V21 connected to a data voltage source Va, a second terminal V22 connected to ground, a third terminal V23 connected to an energy supply and recovery terminal of the energy recovery unit 220, and a fourth terminal connected to the plurality of output terminals Vo1, . . . , Von. The plurality of output terminals Vo1, . . . , Von are connected to the data channels, respectively.

While one output terminal Vo1 of the plurality of output terminals Vo1, . . . , Von is maintained in an on-state, at least one of the other terminals Vo2, . . . , Von goes through an energy recovery operation, an off-state, and an energy supply operation.

The data IC 210 includes a 21-circuit 211, a 22-circuit 212, and a 2n-circuit 21n, where n is the number of data channels.

The 21-circuit 211 includes a 21-high switch QH21 and a 21-low switch QL21 that are connected in series between the first terminal V21 and the second terminal V22. A node N21 between the 21-high switch QH21 and the 21-low switch QL21 is connected to the output terminal Vo1. A 21-switch S21 is connected between the third terminal V23 and the node N21. Because the 22-circuit 212, . . . , and the 2n-circuit 21n have the same configuration as the 21-circuit 211, a description thereof is omitted.

In other words, the data IC 210 includes as many circuits having the same configuration as the 21-circuit 211 as the number of data channels.

The energy recovery unit 220 includes a 21-capacitor C21 connected between the third terminal V23 and ground. The energy recovery unit 220 may further include a 21-inductor L21 connected between the third terminal V23 and the 21-capacitor C21. In case the 21-inductor L21 is included, the 21-capacitor C21 can recover energy by resonance using the 21-inductor L21. Because an inductance of the 21-inductor L21 is substantially small, the 21-inductor L21 may be removed. In case the 21-inductor L21 is removed, the energy recovery efficiency is lowered. However, the energy supply and recovery time can be reduced.

Energy stored in the 21-capacitor C21 is supplied to the output terminal Vo1 by turning on the 21-switch S21, and then the 21-capacitor C21 recovers energy from the output terminal Vo2 by turning on a 22-switch S22. After a predetermined period of time elapses, energy stored in the 21-capacitor C21 is supplied to the output terminal Vo2 by turning on the 22-switch S22, and then the 21-capacitor C21 recovers energy from the output terminal Vo1 by turning on the 21-switch S21.

Because the 21-switch S21 and the 22-switch S22 are not simultaneously turned on, the two output terminals Vo1 and Vo2 are not short. Accordingly, energy is normally supplied to and recovered from the 21-capacitor C21, and energy recovery and supply currents normally flow in the 21-inductor L21.

Because on-time of the data signal is relatively longer than off-time of the data signal, the width of the data signal corresponding to the scan signal widens. Hence, sufficient address discharge time capable of generating the stable address discharge can be secured and the jitter characteristic can be improved.

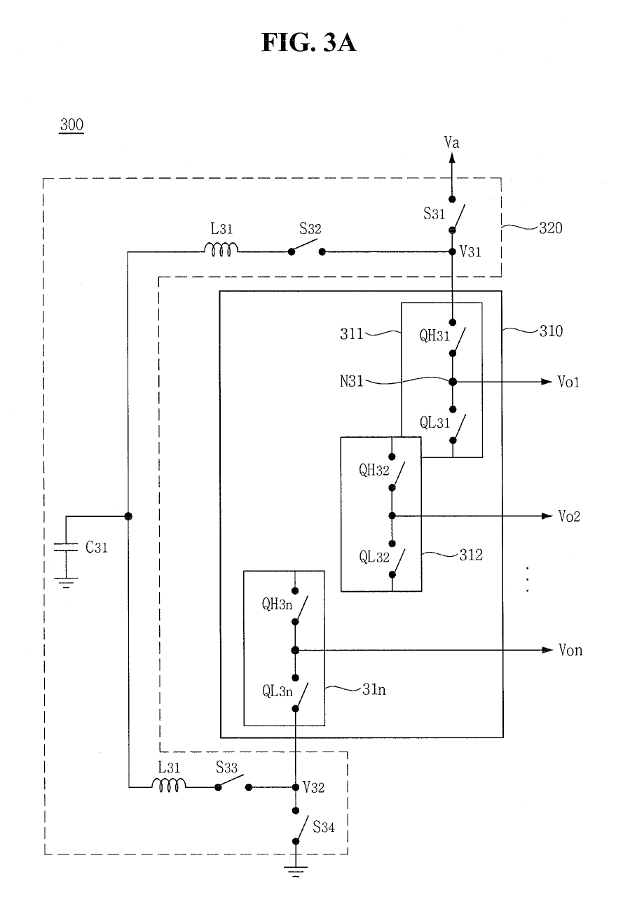

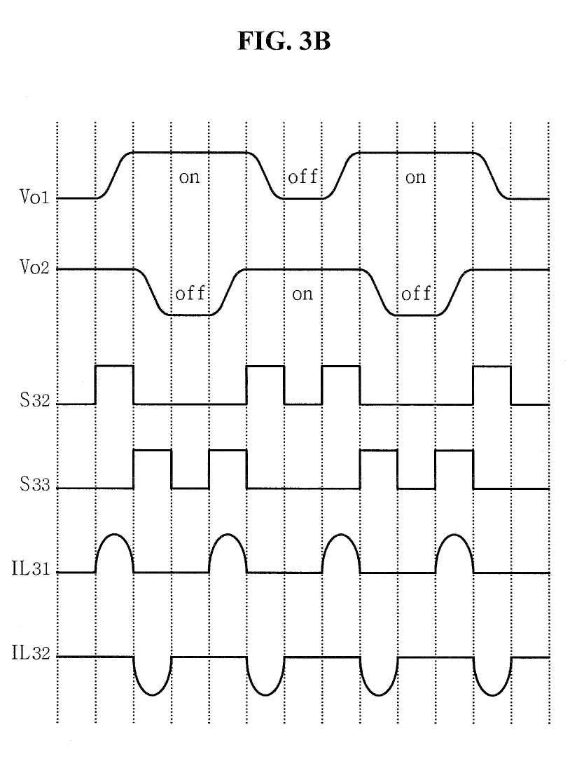

FIG. 3A is a circuit diagram of another data driver of the plasma display apparatus, and FIG. 3B is a timing chart of a waveform for explaining an operation of the circuit shown in FIG. 3A.

As shown in FIGS. 3A and 3B, the plasma display apparatus includes a data driver 300. The data driver 300 includes a data IC 310 and an energy recovery unit 320. The data IC 310 allows one of a plurality of output terminals Vo1, . . . , Von to be in an on-state, and allows at least one of the other output terminals to be in an off-state during off-time shorter than on-time of the on-state.

The data IC 310 includes a first terminal V31 connected to an energy supply terminal of the energy recovery unit 320, a second terminal V32 connected to an energy recovery terminal of the energy recovery unit 320, and a third terminal connected to the plurality of output terminals Vo1, . . . , Von. The first terminal V31 and the second terminal V32 are separated from each other. While one output terminal Vo1 of the plurality of output terminals Vo1, . . . , Von is maintained in an on-state, at least one of the other terminals Vo2, . . . , Von goes through an energy recover operation, an off-state, and an energy supply operation.

The data IC 310 includes a 31-circuit 311, a 32-circuit 312, and a 3n-circuit 31n, where n is the number of data channels.

The 31-circuit 311 includes a 31-high switch QH31 and a 31-low switch QL31 that are connected in series between the first terminal V31 and the second terminal V32. A node N31 between the 31-high switch QH31 and the 31-low switch QL31 is connected to the output terminal Vo1. Because the 32-circuit 312, . . . , and the 3n-circuit 31n have the same configuration as the 31-circuit 311, a description thereof is omitted.

In other words, the data IC 310 includes as many circuits having the same configuration as the 31-circuit 311 as the number of data channels.

The energy recovery unit 320 includes a 31-switch S31, a 32-switch S32, a 31-inductor L31, a 33-switch S33, a 34-switch S34, a 32-inductor L32, and a 31-capacitor C31.

The 31-switch S31 is connected between a data voltage source Va and the first terminal V31. One terminal of the 32-switch S32 is connected to the first terminal V31, and the other terminal is connected to the 31-inductor L31. One terminal of the 31-inductor L31 is connected to the other terminal of the 32-switch S32, and the other terminal is connected to the 31-capacitor C31. The 34-switch S34 is connected between ground and the second terminal V32. One terminal of the 33-switch S33 is connected to the second terminal V32, and the other terminal is connected to the 32-inductor L32. One terminal of the 32-inductor L32 is connected to the other terminal of the 33-switch S33, and the other terminal is connected to the 31-capacitor C31. One terminal of the 31-capacitor C31 is connected to the other terminal of the 31-inductor L31 and the other terminal of the 32-inductor L32, and the other terminal is connected to ground.

Energy stored in the 31-capacitor C31 is supplied to the output terminal Vo1 by turning on the 32-switch S32, and then the 31-capacitor C31 recovers energy from the output terminal Vo2 by turning on the 33-switch S33. After a predetermined period of time elapses, energy stored in the 31-capacitor C31 is supplied to the output terminal Vo2 by turning on the 33-switch S33, and then the 31-capacitor C31 recovers energy from the output terminal Vo1 by turning on the 32-switch S32.

Because the 32-switch S32 and the 33-switch S33 are not simultaneously turned on, the two output terminals Vo1 and Vo2 are not short. Accordingly, energy is normally supplied to and recovered from the 31-capacitor C31, and energy recovery and supply currents normally flow in the 31-inductor L31 and the 32-inductor L32.

Because on-time of the data signal is relatively longer than off-time of the data signal, the width of the data signal corresponding to the scan signal widens. Hence, sufficient address discharge time capable of generating the stable address discharge can be secured and the jitter characteristic can be improved.

As describe above, the driving method of the plasma display apparatus according to the exemplary embodiment performs an asymmetrical drive by allowing on-time of the data signal to be relatively longer than off-time, thereby preventing short between the data channels. Further, the sufficient address discharge time capable of generating the stable address discharge can be secured and the jitter characteristic can be improved.

Embodiments of the invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A method of driving a plasma display apparatus including a plurality of data channels, the method comprising:
supplying a data signal whose on-time is longer than off-time.

2. The method of claim 1, wherein while one of the plurality of data channels is maintained in an on-state, energy is supplied to or recovered from at least one of the other data channels.

3. The method of claim 1, wherein after energy is supplied to one of the plurality of data channels, energy is recovered from at least one of the other data channels, and
after energy is supplied to the at least one of the other data channels, energy is recovered from the one of the plurality of data channels.

4. A plasma display apparatus comprising:
a data driver including a data integrated circuit (IC) and an energy recovery unit,
wherein the data IC allows one of a plurality of output terminals to be in an on-state and allows at least one of the other output terminals to be in an off-state during off-time shorter than on-time of the on-state.

5. The plasma display apparatus of claim 4, wherein the data IC includes a first terminal connected to a data voltage source, a second terminal connected to ground, a third terminal connected to an energy supply and recovery terminal of the energy recovery unit, and a fourth terminal connected to the plurality of output terminals.

6. The plasma display apparatus of claim 5, wherein the data IC includes as many 21-circuits as the number of data channels, and
the 21-circuit includes a 21-high switch and a 21-low switch that are connected in series between the first terminal and the second terminal, a node between the 21-high switch and the 21-low switch is connected to the output terminal, and a 21-switch is connected between the third terminal and the node.

7. The plasma display apparatus of claim 5, wherein the energy recovery unit includes a 21-capacitor connected between the third terminal and ground, and a 21-inductor connected between the third terminal and the 21-capacitor.

8. The plasma display apparatus of claim 5, wherein the data IC includes as many 21-circuits as the number of data channels,
the 21-circuit includes a 21-high switch and a 21-low switch that are connected in series between the first terminal and the second terminal, a node between the 21-high switch and the 21-low switch is connected to the output terminal, and a 21-switch is connected between the third terminal and the node, and
the energy recovery unit includes a 21-capacitor connected between the third terminal and ground, and a 21-inductor connected between the third terminal and the 21-capacitor.

9. The plasma display apparatus of claim 4, wherein the data IC includes a first terminal connected to an energy supply terminal of the energy recovery unit, a second terminal connected to an energy recovery terminal of the energy recovery unit, and a third terminal connected to the plurality of output terminals, and
the first terminal and the second terminal are separated from each other.

10. The plasma display apparatus of claim 9, wherein the data IC includes as many 31-circuits as the number of data channels, and
the 31-circuit includes a 31-high switch and a 31-low switch that are connected in series between the first terminal and the second terminal, and a node between the 31-high switch and the 31-low switch is connected to the output terminal.

11. The plasma display apparatus of claim 9, wherein the energy recovery unit includes:
a 31-switch connected between a data voltage source and the energy supply terminal;
a 32-switch whose one terminal is connected to the energy supply terminal;
a 31-inductor whose one terminal is connected to the other terminal of the 32-switch;
a 34-switch connected between ground and the energy recovery terminal;
a 33-switch whose one terminal is connected to the energy recovery terminal;
a 32-inductor whose one terminal is connected to the other terminal of the 33-switch; and
a 31-capacitor whose one terminal is connected to the other terminal of the 31-inductor and the other terminal of the 32-inductor, and the other terminal is connected to ground.
